(19) United States
(12) Patent Application Publication
(10) Pub. No.: US 2007/0114806 A1
(43) Pub. Date: May 24, 2007

(54) Pick-up tool

(76) Inventor: Willie Al Ferguson, Augusta, GA (US)

Correspondence Address: Willie Al Ferguson, 2605 Polo Court, Augusta, GA, 30904, US

(21) Appl. No.: 11/285,489

(22) Filed: Nov. 23, 2005

(51) Int. Cl. B25J 1/00

(52) U.S. Cl. 294/19.1; 294/25

(57) ABSTRACT

A manually-operated pick-up tool, including a first, stationary portion with an elongated, hollow outer shaft, a first handle portion attached at one end and a first bell carrying a spike retainer ring and a pair of pinch arms attached at the other end. A second, movable portion includes an inner shaft slidable within the outer shaft, a second handle portion attached at one end and a second bell attached at the other end. The stationary and movable portions are operably connected by a connector mechanism which includes a biasing spring; the first and second handle portions are interconnected and include a locking mechanism.

### BACKGROUND OF THE INVENTION

1. Field of the Invention

The present invention relates to the field of hand tools, particularly hand tools used for picking up and moving objects from one place to another. More particularly, the present invention relates to a pick-up device with an activator and arm rest at one end, and pinch arms and spikes at the other end for picking up litter, trash, and the like from different types of surfaces.

2. Discussion of Background

Whatever it is called, the problem of disposing of litter, trash, garbage, debris, or refuse, and the like is nearly universal. Humans generate litter, and do not always dispose of their litter promptly and in an esthetically or environmentally sound manner. Despite the strict anti-littering ordinances passed in many jurisdictions, many people continue to loss empty cans out of their car windows, throw cigarette butts, lunch bags, and disposable cups onto sidewalks, and leave old newspapers on park benches. Because others value trash-free streets, gardens, parks, and buildings, trash pick-up is an important part of property maintenance in both the public and private sectors.

A variety of scoops, grapples, grippers, reachers, spikes, and other tools have been developed in attempts to provide efficient and convenient tools for trash pick-up. (For purposes of this specification, the terms “trash,” “garbage,” “litter,” “debris,” and “refuse” are used interchangeably.) Many of these permit an operator to collect trash from the ground without having to bend down, and without having to directly touch the item being retrieved. For example, Hollis (U.S. Pat. No. 3,527,492) shows a trash pick-up device that includes a hollow shaft with jaws positioned at the lower end. The jaws are connected to a cable that extends through the shaft to a handle at the upper end. Operating an actuator in the handle moves the cable to open and close the jaws.

Scripter's waste collection device (U.S. Pat. No. 4,962,956) has an elongated handle with a flexible frame at the lower end. The frame carries a disposable, flexible bag into which the user can scoop trash such as animal waste.

Traber (U.S. Pat. No. 4,962,957) has a shaft with a pair of pick-up fingers at one end and a trigger-type handle at the other end. The handle includes a slidable arm and a lever for retaining the arm in contact with a stop for positioning the fingers in a first, fully-opened position, and a second position that allows free movement of the fingers from the open position to a second, fully-closed position. As the trigger is squeezed against the handle, the fingers are drawn together so as to hold an object.

Tucker (U.S. Pat. No. 4,709,839) provides a shoe butler having a shaft with a trigger-type handle and one end, and a shoe horn and a chuck at the other end. The handle can be operated to draw the chock into contact with the shoe horn to clasp the shoe therebetween.

Additional types of gripping tools include Okada (U.S. Pat. No. 5,020,963), a device used for clamping a container such as a cylindrical drum. The device includes a support frame that can be positioned about approximately one half the circumference of the container, a pair of horizontal support rods on the inner side of the frame near its opposite ends, and a pair of claw plates mounted on the support rods. The device clamps a container simply by pushing it against the container; the container is released by pulling it away from the device.

Ricc, Jr. (U.S. Pat. No. 4,211,158) shows a device for holding food articles that are impaled on sticks (corn dogs, popsicles, and so forth). The device has a body with two transverse grooves (the second groove positioned inside the first groove) and a spring clip positioned over the grooves to hold a stick in place. The grooves are shaped to hold sticks with rectangular cross-section circular cross-section.

Hamilton (U.S. Pat. No. 4,482,131) shows a nail extractor for removing nails from boards. His device is an elongated rod with a socket at one end, and a head with a groove shaped to grip nails at the other end. When the shank of a nail is lodged in the groove, an impact wrench is engaged with the socket and turned on for a brief period, causing a short turn which rolls the device to the side and lifts the nail from the board.

Typical grasping tools and pick-up tools are useful for picking up one type of object: scoops are useful for picking up and disposing of some types of litter, magnets are useful for picking up some metal objects, and spikes are useful for picking up waste paper. Thus, an operator frequently has to carry several different tools in order to do thoroughly clean up an area. In addition, many pick-up tools are cumbersome and difficult to operate, and tiling to use for more than short periods of time. There is a need for an ergonomically sound tool that can be used to pick up several different types of litter.

### SUMMARY OF THE INVENTION

According to its major aspects and broadly stated, the present invention is a manually-operated pick-up tool for picking up litter. The pick-up tool includes a first, stationary portion with an elongated, hollow outer shaft, a first handle portion attached at one end and a first bell carrying a spike retainer ring and a pair of pinch arms attached at the other end. A second, movable portion includes an inner shaft slidable within the outer shaft, a second handle portion attached at one end and a second bell attached at the other end. The stationary and movable portions are operably connected by a connector mechanism which includes a biasing spring, the first and second handle portions are interconnected and include a locking mechanism.

In use, the operator of the pick-up tool positions it appropriately near an object to be picked up, then pulls the second handle portion outwards to move the pinch arms from their normally-open position to a closed position grasping the object. He then locks the pinch arms in the closed position, moves the pick-up tool (with the object) to a desired location such as a trash container, unlocks the pinch arms to drop the object into the container. To pick up a piece of paper or some other object that cannot readily be gripped between the pinch arms, the operator uses a spike or nail assembly carried by the first and second bells.

An important feature of the present invention is its versatility. By providing at least two pick-up devices—clamps and spikes—the invention allows picking up of a wider variety of objects with a single tool. If desired, additional pick-up devices can be added to the pick-up assembly, such as magnets or components made of magnetized materials to be used in picking up metal objects.

Another important feature of the present invention is its ergonomic design. The pick-up tool is made of sturdy, light-weight materials (either light-weight metal or plastic), so it is easy to use for extended periods of time. An arm rest attached to the handle furthers operator comfort and safety, and also helps prevent repetitive stress injuries by keeping the operator's arm in a physiologically correct position.

Still another feature of the present invention is the pair of bells. The bells carry both the pinch arms and the spike assembly, either of which can be called into play for picking up litter.

Yet another feature of the present invention is the locking mechanism attached to the handles. The locking mechanism is activated by the operator when the pinch arms reach their closed position (for holding an object to be picked up), and is easy to unlock in order to release the object.

Other features and advantages of the present invention will be apparent to those skilled in the art from a careful reading of the Detailed Description of Preferred Embodiments presented below and accompanied by the drawings.

### BRIEF DESCRIPTION OF THE DRAWINGS

In the drawings,

FIG. 1 is a perspective view of a pick-up tool according to a preferred embodiment of the present invention;

FIG. 2 is a top view of the pick-up tool of FIG. 1, showing, the pinch arms in an open position; and

FIG. 3 is a side, cross-sectional view of the pick-up tool of FIG. 1.

### DETAILED DESCRIPTION OF PREFERRED EMBODIMENTS

In the following detailed description of the invention, reference numerals are used to identify structural elements, portions of elements, surfaces or areas in the drawings, as such elements, portions, surfaces or areas may be further described or explained by the entire written specification. For consistency, whenever the same numeral is used in different drawings, it indicates the same element, portion, surface or area as when first used. Unless otherwise indicated, the drawings are intended to be read together with the specification, and are to be considered a portion of the entire written description of this invention as required by 35 U.S.C. §112. As used herein, the terms “horizontal,” “vertical,” “left,” right,” “up,” “down,” as well as adjectival and adverbial derivatives thereof, refer to the relative orientation of the illustrated structure as the particular drawing figure faces the reader.

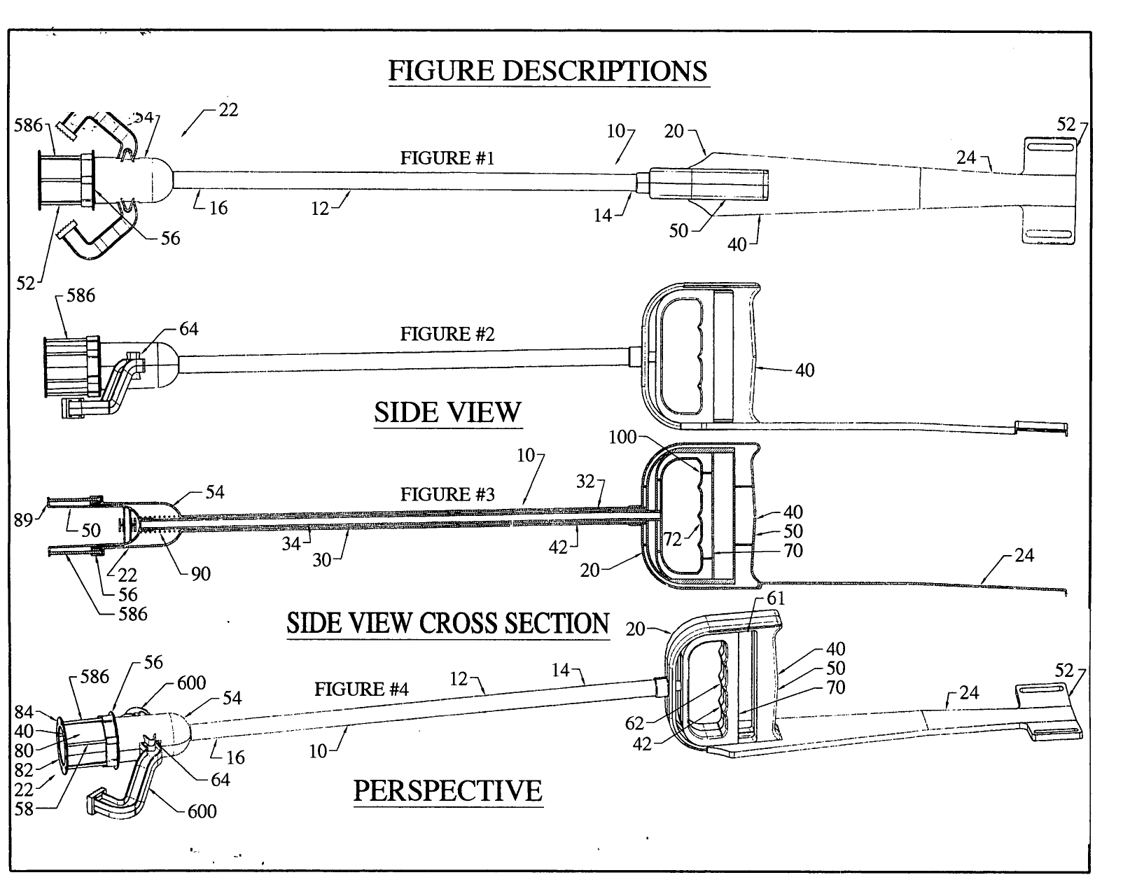

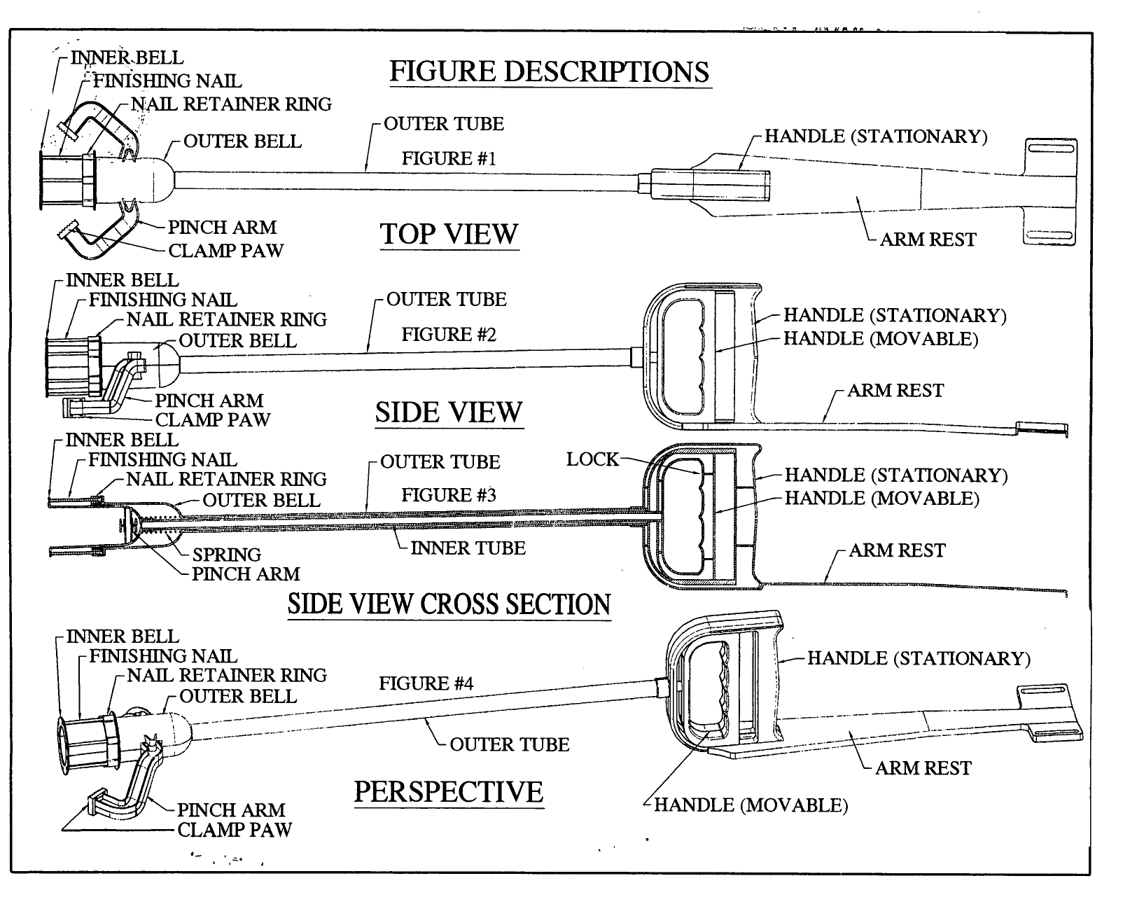

Referring now to FIGS. 1-3, there is shown a pick-up tool 10 according to a preferred embodiment of the present invention. Pick-tip tool 10 includes an elongated, hollow outer shaft 12 with an upper end 14 and a lower end 16, a graspable handle assembly 20 operably connected to upper end 14, and a pick-up assembly 22 operably connected to lower end 16. An arm rest 24 is mounted to handle assembly 20. An elongated inner shaft 30 is operably connected to handle assembly 20 and pick-up assembly 22 at upper and lower ends 32 and 34, respectively. Together, these components form a first, stationary portion 40 and a second, movable portion 42 of pick-up tool 10: as will be described further below, stationary portion 40 includes outer shaft 12, movable portion 42 includes inner shaft 30, and portions 40 and 42 each include components of handle assembly 20 and pick-up assembly 22.

Stationary portion 40 has a first handle portion 50 attached to upper end 14 of outer shaft 12. First handle portion 50 is approximately “D”-shaped as shown, and preferably includes suitably-shaped grooves, notches, or other mechanism (not shown) for securing arm rest 24 thereto. Arm rest 24 is formed with a flange 52 at its outer end. Arm rest 24 and flange 52 may be approximately straight, but are preferably somewhat curved to more comfortably accommodate the operator's forearm.

A first, outer bell 54 is attached to lower end 16 of outer shaft 12. A circumferential nail or spike retainer ring 56 is secured to outer bell 54, a plurality of nails or spikes 58a, 58b, , , , are carried by ring 56. In a preferred embodiment of the invention, a pair of movable pinch arms 60a, 60b, each terminating in a clamp paw 62, are operably connected to outer bell 54 via a connector mechanism 64.

Movable portion 42 includes a second handle portion 70 attached to upper end 32 of inner shaft 30. Second handle portion 70 is approximately “D”-shaped, and may have a grip 72 formed with grooves for receiving the operator's fingers. In use, second handle portion 70 acts as a trigger for operating pick-up tool 10.

A second, inner bell 80 is attached to lower end 34 of inner shaft 30. Inner bell 80 is formed with a flange 82 having a plurality of throughholes 84a, 84b, . . . . Throughholes 84a, 84b are aligned so that nails 58a, 58b, . . . are slidable therein. A spring 90 is connected between inner bell 80 and outer bell 54 generally as shown, and generates tension between the bells. The biasing action of spring 90 maintains pinch arms 60a, 60b in an open position, and also maintains second handle portion 70 in the open position shown in FIG. 1.

[For a utility patent application, we would include more details about the structure of the inner and outer bells. For this provisional application, I recommend keeping the description fairly general.]

[Let's consider adding a diagram of the locking mechanism, and perhaps a diagram of the bells.]

In use, the operator of pick-up tool 10 locates an object to be picked up, and positions the tool so that pick-up assembly 22 is proximate the object. He or she then moves portions 40 and 42 with respect to each other by gripping first and second handle portions 40 and 70 with his or her fingers against grip 72. The operator then pulls second handle portion 70 (with inner shaft 30 and inner bell 80) outwards relative to first handle portion 40 (and outer shaft 12 and outer bell 54). Inner bell 80 moves against the biasing action of spring 90, and the cam action of connector mechanism 64 move pinch arms 60a, 60b towards their closed position, gripping the object therebetween. As movable portion 42 is translated relative to stationary portion 40, a spring-loaded locking mechanism 100 (FIG. 3) engages one of tracks 72. Locking mechanism 100 retains pinch arms 60a, 60b in their closed position until released by the operator. The operator moves pick-up tool 10 (with the object firmly gripped by pinch arms 60a, 60b) to a desired location (such as a trash container), and releases locking mechanism 100 to release the object.

If the operator wishes to pick up a piece of paper of other hard-to-grip object, he pulls second handle portion 70 by about ½″-¾″ to expose nails 84a, 84b, . . . . Rotating his wrist by about 90 degrees, he then stabs the object with nails 84a, 84b, . . . . Operating locking mechanism 100 releases second handle portion 70, which moves forward so that the object is pushed off nails 82a, 82b, . . . by inner bell 80.

Because pick-up tool 10 is made of sturdy, light-weight materials, it can be used for extended periods of time (up to a full working day). The pick-up tool is ergonomically sound: by resting his or her arm on arm rest 24, the operator lessens strain on the arm and wrist and thereby reduces the risk of developing repetitive stress injuries. In addition, pick-up tool 10 has no “handedness”: it can be used by either left-handed or right-handed operators.

[is this correct?]

The components of pick-up tool 10 may be made of any suitable materials, preferably light-weight, durable materials suitable for either indoor or outdoor use. For example, any or all of shafts 12 and 14, bells 54, ring 56, handle portions 50 and 60, and arm rest 24 may be made of a lightweight metal such as aluminum, or more preferably of plastics such as PVC, TEFLON, or the like.

The components of pick-up tool 10 may be attached to each other, where needed, by any convenient techniques. For example, metal components may be attached by welding or brazing, or by nuts and bolts, screws, rivets, or the like. Plastic components may be attached to each other by LEXAN solvent or other adhesive, or by any suitable fasteners.

Clamp paws 62 may be made of metal, plastic, composite materials, or indeed any suitable material. In a preferred embodiment of the invention, the paws are somewhat flexible in order to facilitate picking up smooth objects.

Each of handle portions 50 and 60, an inner and outer bells 54 and 80, is preferably made in two halves that are snapped together along a mutual centerline to form a single structure. Stiffening ribs may be formed in each half to help provide rigidity, and structural features such as mating grooves and channels may help secure the two halves of each component together.

The dimensions of pick-up tool 10 may vary widely. The lengths of outer shaft 12 and inner shaft 30 are such that the operator can use pick-up device comfortably while in a standing position, without needing to bend or stoop unduly. Handle assembly 20 is dimensioned for a typical adult-size hand.

[Do you wait to include a belt or shoulder strap, or fittings that would allow the operator to attach the tool to a belt?]

[Can either (or both) of the bells be made of a ferromagnetic material? This might help when picking up metal objects.]

With respect to the above description of the invention, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing description is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. Thus, it will be apparent to those skilled in the art that many changes and substitutions can be made to the preferred embodiment herein described without departing from the spirit and scope of the present invention as defined by the appended claims.

What is claimed is:

1. A pick-up tool, comprising:
a stationary portion having an upper end and a lower end;
a movable portion having an upper end and a lower end;
a handle assembly operably connected between said upper end of said stationary portion and said upper end of said movable portion;
a pick-up assembly operably connected between said lower end of said stationary portion and said lower end of said movable portion;
pick-up means operably connected to said pick-up assembly, said pick-up means having an open position and a closed position;
means biasing said pick-up means towards said open position; and
user-operable trigger means for moving said pick-up means between said open and closed positions.

2. The pick-up tool as recited in claim 1, further comprising lock means for securing said pick-up means in said closed position said lock means operably connected to said trigger means.

3. The pick-up tool as recited in claim 1, wherein said pick-up means further comprises clamp means operable for securing an object.

4. The pick-up tool as recited in claim 1, wherein said pick-up means further comprises spike means operable for securing an object.

5. The pick-up tool as recited in claim 1, wherein said biasing means further comprises spring means operably connected between said stationary portion and said movable portion.

6. A pick-up tool, comprising:
a first hollow shaft having an upper end and a lower end;
a second hollow shaft having an upper end and a lower end, said second shaft slidable in said first shaft;
a handle assembly having a first portion attached to said upper end of said first shaft and a second portion attached to an upper end of said second shaft, said second portion movable with respect to said first portion;
a pick-up assembly having a first portion attached to a lower end of said first shaft and a second portion attached to a lower end of said second shaft;
pick-up means operably connected to said pick-up assembly, said pick-up means having an open position and a closed position; a spring operably connected between said first and second portions of said pick-up assembly, said spring biasing said pick-up means towards said open position; and
lock means for securing said pick-up means in said closed position.

7. The pick-up tool as recited in claim 6, wherein said pick-up means further comprises a pair of clamps operable for securing an object therebetween.

8. The pick-up tool as recited in claim 6, wherein said pick-up means further comprises a plurality of spikes operable for securing an object thereto.

9. The pick-up tool as recited in claim 6, further comprising an arm rest attached to said first portion of said handle assembly.
